(19) United States
(12) Patent Application Publication
(10) Pub. No.: US 2024/0202428 A1
(43) Pub. Date: Jun. 20, 2024

(54) METHOD, DEVICE, COMPUTER EQUIPMENT AND STORAGE MEDIUM FOR PROCESSING PDF FILES

(71) Applicant: KDAN MOBILE SOFTWARE LTD., Tainan City (TW)

(72) Inventors: SHENG-JUN LU, Tainan City (TW); WEN-ZHONG YIN, Tainan City (TW); CHAO WANG, Tainan City (TW); PO-CHOU SU, Tainan City (TW); WEN-WEI LIN, Tainan City (TW)

(21) Appl. No.: 18/388,217

(22) Filed: Nov. 9, 2023

(30) Foreign Application Priority Data
Dec. 19, 2022 (CN) 202211634325.6

(51) Int. Cl. G06F 40/157; G06F 40/205

(52) U.S. Cl. CPC G06F 40/157; G06F 40/205

(57) ABSTRACT

There is provided a method for processing tables in a PDF file, including: parsing the PDF file to obtain coordinates of start points and end points of all transverse line sections and longitudinal line sections; obtaining coordinates of crosspoints of all line sections and recording coordinates of line sections that form the crosspoints; calculating all unit grids according to the coordinates of the crosspoints and the coordinates of the line sections; and filling every character respectively into a corresponding unit grid according to character coordinates obtained in parsing the PDF file.

### CROSS-REFERENCE TO RELATED APPLICATIONS

This application claims the priority benefit of Chinese Patent Application Serial Number 202211634325.6, filed on Dec. 19, 2022, the full disclosure of which is incorporated herein by reference.

### FIELD OF THE DISCLOSURE

This disclosure generally relates to the file processing and, more particularly, to a method, a device, a computer equipment and a storage medium for transforming tables in a portable document format to a target document.

### BACKGROUND OF THE DISCLOSURE

The portable document format (PDF) file and the Office Software are both generally used electronic files. Although a PDF file can be read almost on any operating system, contents of the PDF file do not include table objects and it is difficult to edit the PDF file. During editing a PDF file, the PDF file is generally transformed to a file having another format. However, although tables are also generally used electronic files, current techniques are not able to directly transform the tables in a PDF file to a format of an Office Software or other table-form document.

Accordingly, the present disclosure further provides a method, a device, a computer equipment and a storage medium that can recognize and divide tables in a PDF file and transform the tables to other file formats.

### SUMMARY

The present disclosure provides a method, a device, a computer equipment and a storage medium for processing tables in a PDF file that firstly parse start/end coordinates of all line sections according to path objects parsed from the PDF file, and then calculate all unit grids and divide different tables according to crosspoints of all line sections.

The present disclosure provides a method for transforming tables in a PDF file into a target document, including the steps of: parsing the PDF file to obtain coordinates of start points and end points of all transverse line sections and longitudinal line sections; obtaining coordinates of crosspoints of all line sections and recording coordinates of line sections that form the crosspoints; calculating all unit grids according to the coordinates of the crosspoints and the coordinates of the line sections; filling every character respectively into a corresponding unit grid according to character coordinates obtained in parsing the PDF file; and generating the target document.

The present disclosure further provides a device for processing tables in a PDF file. The device includes a non-volatile storage medium, a memory and a processor. The non-volatile storage medium is configured to record a computer program. The memory is configured to provide environment for operations of the computer program in the non-volatile storage medium. The processor is configured to run the computer program to parse the PDF file, record coordinates of start points and end points of all transverse line sections and longitudinal line sections as well as character coordinates into the memory, calculate coordinates of crosspoints of all line sections and coordinates of line sections that form the crosspoints to be stored in the memory, calculate all grid units according to the coordinates of the crosspoints and the coordinates of the line sections, and fill every character respectively into a corresponding unit grid according to the character coordinates.

The present disclosure further provides a computer equipment including a storage device and a processor. The storage device is used to record a computer program. The processor is used to run the computer program in the storage device to execute the embodiment of a method for processing tables in a PDF file.

The present disclosure further provides a content accessible memory recorded with a computer program. The computer processor is run by a processor to implement the embodiment of a method for processing tables in a PDF file.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic block diagram of a computer equipment according to one embodiment of the present disclosure.

FIG. 2 is a flow chart of a method for processing tables in a PDF file according to one embodiment of the present disclosure.

FIGS. 3A to 3C are schematic diagrams of the Step S21 in FIG. 2.

FIG. 4 is a schematic diagram of the Step S22 in FIG. 2.

FIG. 5 is a schematic diagram of the Step S24 in FIG. 2.

FIGS. 6A and 6B are schematic diagrams of the Step S25 in FIG. 2.

### DETAILED DESCRIPTION OF THE DISCLOSURE

It should be noted that, wherever possible, the same reference numbers will be used throughout the drawings to refer to the same or like parts.

One objective of the present disclosure is to provide a method for processing tables (including recognizing, dividing or the like) in a portable document format (PDF) file, and a device, a computer equipment and a content accessible memory using the same. The present disclosure further transforms the tables in the PDF file to a target document for being edited by a user.

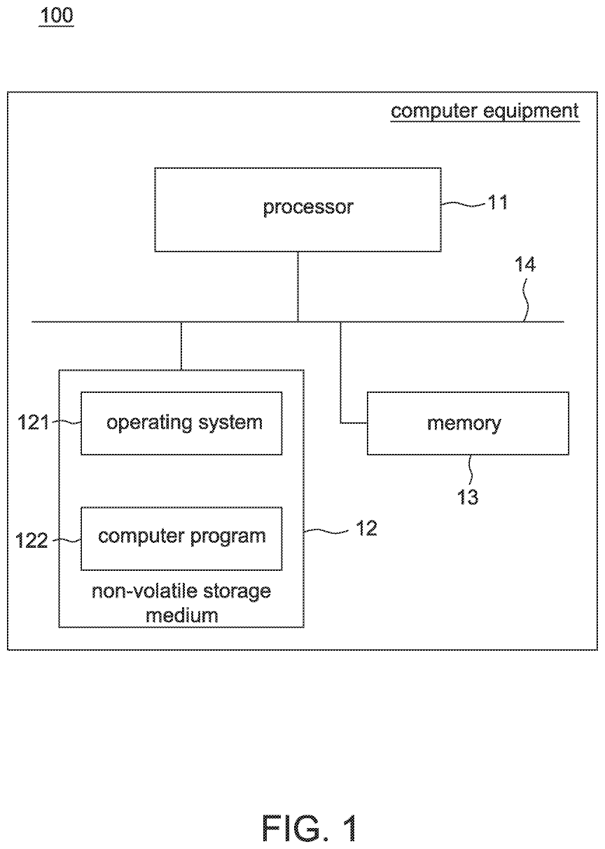

Please refer to FIG. 1, it is a schematic block diagram of a computer equipment 100 according to one embodiment of the present disclosure. The computer equipment 100 is equipment capable of reading and/or transforming PDF files such as a desktop computer, a tablet computer or a notebook computer without particular limitations.

The computer equipment 100 includes a processor 11 and a storage device connected via a bus 14. The storage device includes a non-volatile storage medium 12 and a memory 13. The non-volatile storage medium 12 records an operating system (OS) 121 and a computer program 122. The computer program 122 includes programs for running a method of processing tables in a PDF file according to the embodiments of the present disclosure. The method is described by an example hereinafter.

The processor 11 includes, for example, a central processing unit (CPU) and/or a micro processing unit (MCU) that provides calculation and control capability to support operations of the computer equipment 100. Methods that the processor 11 runs the operating system 121 and the computer program 122 and accesses the memory 13 via the bus 14 are known to the art, and thus details thereof are not described herein.

The memory 13 provides an environment of operations of the computer program 122 in the non-volatile storage medium 12, e.g., recording contents of path objects (e.g., including coordinates of start/end points , colors, line widths of line sections, but not limited to), text objects (e.g., including fonts, coordinates, colors, sizes of characters, but not limited to), and image objects obtained in parsing the PDF file, and is for being accessed by the processor 11 according to the computer program 122.

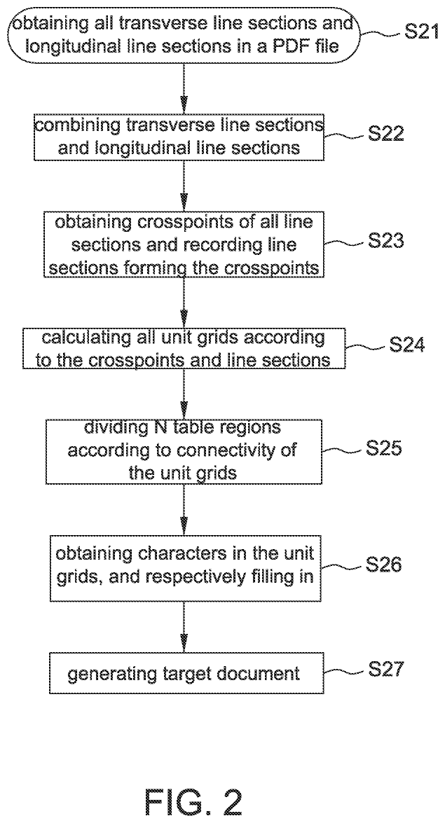

Please refer to FIG. 2, it is a flow chart of a method for processing tables in a PDF file by the computer equipment 100 according to one embodiment of the present disclosure. The method includes the steps of: parsing a PDF file to obtain coordinates of start points and end points of all transverse line sections and longitudinal line sections (Step S21); combining the transverse line sections and the longitudinal line sections (Step S22); obtaining coordinates of crosspoints of all line sections and recording coordinates of line sections that form the crosspoints (Step S23); calculating all unit grids according to the coordinates of the crosspoints and the line sections (Step S24); dividing table regions according to connectivity of all unit grids (Step S25); filling every character respectively into a corresponding unit grid according to character coordinates obtained in parsing the PDF file (Step S26); and generating a target document (Step S27). The method for processing tables in a PDF file of the present disclosure is described hereinafter by an example.

Step S21: The processor 11 runs the computer program 122 to parse a PDF file. The PDF file is, for example, a file designated by a user, and the parsed contents are recorded in the memory 13.

The parsing PDF file of the present disclosure is, for example, to record, using a user defined source language, contents of the PDF file, e.g., including path objects, text objects or the like, into the memory 13 for being accessed by the computer program 122 for the following calculations, e.g., including calculating coordinates of crosspoints, calculating unit grids, dividing table regions and filling characters as described below.

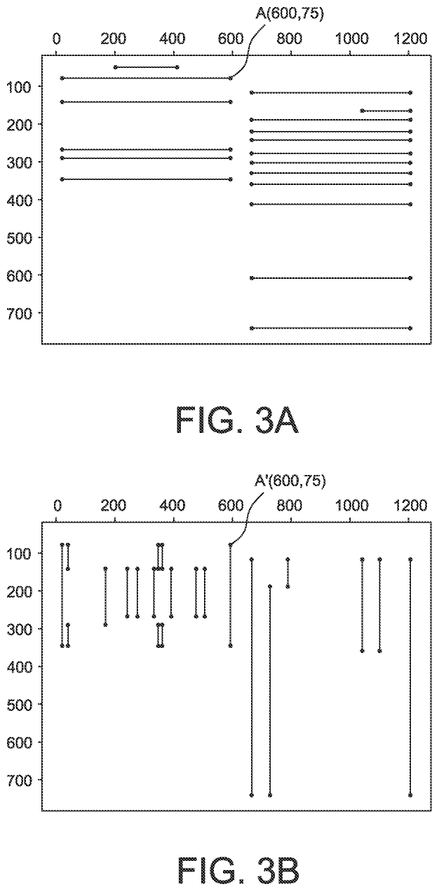

For example, FIG. 3A shows all transverse line sections, and terminal coordinates (shown by dots) at two terminals (i.e. start points and end points) of each transverse line section obtained by the processor 11; FIG. 3B shows all longitudinal line sections, and terminal coordinates (shown by dots) at two terminals (i.e. start points and end points) of each longitudinal line section obtained by the processor 11; and FIG. 3C is a schematic diagram of putting all transverse line sections and longitudinal line sections on the same two-dimensional space (e.g., created in the memory). The two-dimensional space is preferable corresponding to an area of a displayed image on a screen of the computer equipment. In the present disclosure, coordinates are, for example, values or positions corresponding to a transverse axis and a longitudinal axis in FIGS. 3A to 3C. For example, both a point A and a point A′ have coordinates (600,75).

It should be mentioned that the computer equipment 100 does not need to show FIGS. 3A to 3C on a user interface (e.g., the screen), and FIGS. 3A and 3C are shown herein only for illustration purposes. The computer equipment 100 records, e.g., using a user defined data structure, every line section (including the transverse line sections and the longitudinal line sections) and coordinates of start/end points thereof in the memory 13. Furthermore, dots shown in FIGS. 3A to 3C are only intended to illustrate, and computer equipment 100 does not need to form the dots at two terminals of a line section.

Step S22: When the processor 11 recognizes (using the computer program 122 being executed) that two line sections are too close to each other (e.g., a distance therebetween being smaller than or equal to predetermined number of pixels, e.g., 3 pixels, which is determined according to the resolution), the two line sections are combined to one line section.

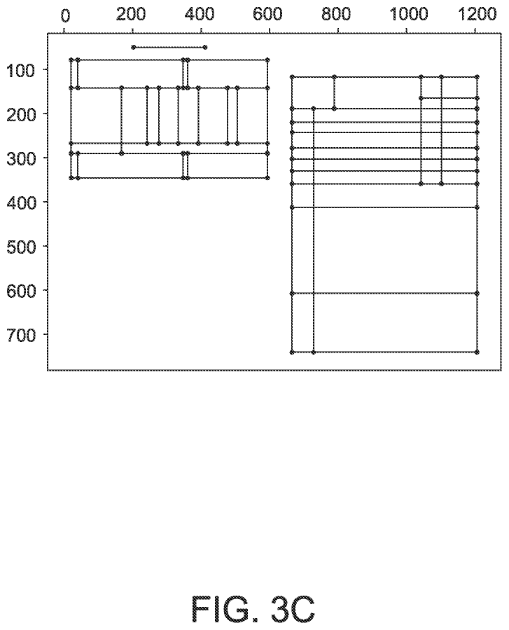

Please refer to FIG. 4, it shows a first transverse line section LS11 and a second transverse line section LS22 after parsing the PDF file. When identifying that a transverse distance between the first transverse line section LS11 and the second transverse line section LS22 Is smaller than or equal to a predetermined pixel numbers, the processor 11 combines, using expansion procedure, the first transverse line section LS11 and the second transverse line section LS22 into one transverse line section LS1, i.e. changing two line sections in the memory 13 to one line section, e.g., changing 4 terminals to 2 terminals. The method for processing longitudinal line sections is similar, and thus details thereof are not repeated herein.

The Step S22 is an optional step.

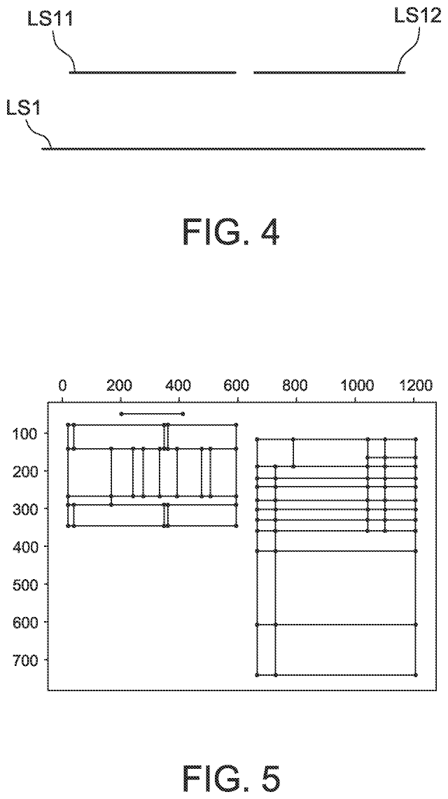

Step S23: Please refer to FIG. 5, the processor 11 then calculates coordinates of crosspoints (e.g., also shown as dots) of all line sections (including transverse line sections and longitudinal line sections) and coordinates of line sections that form the crosspoints (i.e. line sections connecting to the same crosspoints) to be stored in the memory 13. The coordinates are values or positions corresponding to a transverse axis and a longitudinal axis in FIG. 5. It is seen from FIGS. 5 and 3 that FIG. 5 further includes multiple coordinates of crosspoints (i.e. the dots), which are stored in the memory 13 using the user defined data structure.

Step S24: Referring to FIG. 5 again, the processor 11 calculates all unit grids according to the coordinates of the crosspoints and the line sections obtained in Step S23. In one aspect, each unit grid is consisted of coordinates of four crosspoints. In another aspect, each grid unit is consisted of four sides. In a further aspect, each grid unit is consisted of coordinates of four crosspoints and four sides. That is, each unit grid and the associated coordinates of four crosspoints and/or four sides (i.e. a line section between two crosspoints) are recorded by the user defined data structure in the memory 13.

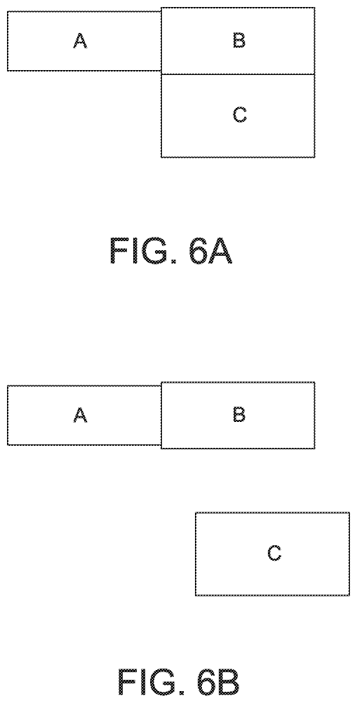

Step S25: This step is used to divide multiple table regions in the PDF file. For example, referring to FIG. 6A, it shows three unit grids A, B and C. One side of the unit grid A is connected to one side of the unit grid B, and one side of the unit grid B is connected to one side of the unit grid C. For example, when identifying that crosspoints of two crosspoints of the unit grid A and the unit grid B are overlapped (or smaller than or equal to a predetermined pixel distance) and/or one side of the unit grid A and the unit grid B is overlapped (or smaller than or equal to a predetermined pixel distance), it means that the two unit grids are connected to each other (i.e. with connectivity). For example, referring to FIG. 6B, it shows that the unit grid B and the unit grid C are not connected to each other (i.e. no connectivity). The processor 11 identifies that the unit grids A, B and the unit grid C in FIG. 6B are two table regions. The processor 11 sequentially identifies the connectivity of every unit grid recorded in the memory 13 with adjacent unit grids thereof. In this way, it is able to identify two table regions as shown in FIG. 5, e.g., a left table and a right table.

After this step, the memory 13 records data associated with different tables according to the user defined data structure. For example, the memory 13 records the left table as a Table I (or Module I), and a position of the Table I, as well as all unit grids in the Table I and coordinates of four crosspoints and/or four sides associated with each unit grid in the Table I. The memory 13 also records the right table as a Table II (or

Module II), and a position of the Table II, as well as all unit grids in the Table II and coordinates of four crosspoints and/or four sides associated with each unit grid in the Table II.

However, if it is known that there is only one table in a PDF file, the Step S25 is not performed by the computer program.

Step S26: As mentioned above, after parsing the PDF file by the processor 11, text objects are also recorded in the memory 13, e.g., including coordinates of characters. The processor 11 then fills all characters sequentially into corresponding unit grids (coordinate range of each unit grid being known after the Step S24) according to the coordinate of every character so as to finish the recognition procedure of tables of the present disclosure.

In the present disclosure, the path objects and the text objects can be obtained in the same or different stages. For example in one aspect, the path objects are acquired in the Step S21 but the text objects are acquired in the Step S26. In another aspect, the path objects and the text objects are both acquired in the Step S21 to be recorded in the memory 13.

Step S27. Finally, after all unit grids are calculated and filled with the corresponding characters, a target document is generated according to a format of the target document.

In the present disclosure, the target document is, for example, Office Software including Word, Excel, Access, Outlook, PowerPoint, but not limited to.

The target document may be other document formats, e.g., xls format or Numbers format, but not limited to.

The format and writing of the target document are known to the art, i.e. using the conventional method to generate the target document, and thus details thereof are not described herein. The main objective of the present disclosure is to provide a method for processing tables in the PDF file.

The present disclosure further provides a computer equipment including a storage device and a processor 11. The storage device is used to record a computer program 122. The processor 11 is used to run the computer program 122 in the storage device to perform the method of processing tables in the PDF file as shown in FIG. 2.

The present disclosure further provides a content accessible memory 12 which records a computer program 122. The computer program 122 is run by the processor 11 to implement the method of processing tables in the PDF file as shown in FIG. 2.

As mentioned above, because contents of a PDF file do not include table objects, the prior art is not able to transform tables in the PDF file directly into formats of Office Software or other table-form documents. Accordingly, the present disclosure further provides a method (e.g., referring to FIG. 2), a device, a computer equipment and a storage medium (e.g., referring to FIG. 1) that recognize tables in a PDF file and transform the recognized tables into other document formats. Therefore, users can transform the tables in the PDF file according to a format of a target document to facilitate the editing the tables.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A method for transforming tables in a portable document format (PDF) file to a target document, the method comprising:
parsing the PDF file to obtain coordinates of start points and end points of all transverse line sections and longitudinal line sections;
obtaining coordinates of crosspoints of all line sections and recording coordinates of line sections that form the crosspoints;
calculating all unit grids according to the coordinates of the crosspoints and the coordinates of the line sections;
filling every character respectively into a corresponding unit grid according to character coordinates obtained in parsing the PDF file; and
generating the target document.

2. The method as claimed in claim 1, further comprising:
combining two transverse line sections into one transverse line section, and
combining two longitudinal line sections into one longitudinal line section.

3. The method as claimed in claim 1, further comprising:
dividing table regions according to connectivity of the all unit grids.

4. The method as claimed in claim 1, wherein the target document is Office Software.

5. The method as claimed in claim 1, wherein each of the unit grids is consisted of coordinates of four crosspoints.

6. A device configured to process tables in a PDF file, the device comprising:
a non-volatile storage medium, configured to record a computer program;
a memory, configured to provide environment for operations of the computer program in the non-volatile storage medium; and
a processor, configured to
run the computer program to parse the PDF file,
record coordinates of start points and end points of all transverse line sections and longitudinal line sections as well as character coordinates into the memory,
calculate coordinates of crosspoints of all line sections and coordinates of line sections that form the crosspoints to be stored in the memory,
calculate all grid units according to the coordinates of the crosspoints and the coordinates of the line sections, and
fill every character respectively into a corresponding unit grid according to the character coordinates.

7. The device as claimed in claim 6, wherein the processor is further configured to
combine two transverse line sections into one transverse line section, and
combine two longitudinal line sections into one longitudinal line section.

8. The device as claimed in claim 6, wherein the processor is further configured to divide table regions according to connectivity of the all unit grids.

9. A computer equipment, comprising:
a storage device, configured to record a computer program; and
a processor, configured to run the computer program recorded in the storage device to perform the method as claimed in claim 1.

10. The computer equipment as claimed in claim 9, wherein the method further comprises:
combining two transverse line sections into one transverse line section, and
combining two longitudinal line sections into one longitudinal line section.

11. The computer equipment as claimed in claim 9, wherein the method further comprises:
dividing table regions according to connectivity of the all unit grids.

12. The computer equipment as claimed in claim 9, wherein the target document is Office Software.

13. The computer equipment as claimed in claim 9, wherein each of the unit grids is consisted of coordinates of four crosspoints.
